(19) United States
(12) Patent Application Publication
(10) Pub. No.: US 2009/0138255 A1
(43) Pub. Date: May 28, 2009

(54) CUSTOMER FACING DEVICE HAVING LANGUAGE TRANSLATION CAPABILITIES

(75) Inventors: Jake Sterling, Creve Coeur, MO (US); Howard W. Fish, Highlands Ranch, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/945,080

(22) Filed: Nov. 26, 2007

(51) Int. Cl. G06F 17/28; G06Q 40/00; G01C 21/00

(52) U.S. Cl. 704/2; 705/39; 701/300

(57) ABSTRACT

This disclosure describes, generally, methods and systems for providing a customer facing device (CFD) with language translation capabilities. The method may include receiving a card swipe from a presentation instrument for a financial transaction at the CFD. The method may further extract location information from the presentation instrument (or other identification instrument) and, based on the extracted location information, determine a home language associated with the presentation instrument. Further, the method may present information displayed on the CFD in the home language.

### FIELD OF THE INVENTION

The present invention relates, in general, to customer facing devices, and more particularly, to customer facing devices which have language translation capabilities.

### BACKGROUND

Presently, customer facing devices (CFDs) such as an automatic teller machine (ATM) or a point of sale (POS) device typically provide a customer with the option of choosing between one of two default languages (e.g., English or Spanish). The language options are “hard-coded” into the CFD and are presented to the customer regardless of the actual language needs of the customer. As a result, if the customer needs a different language (e.g., Japanese), current CFDs are unable to dynamically present the customer with their desired language. The present invention addresses these and other problems with current implementations.

### BRIEF SUMMARY

The tools provided by various embodiments of the invention include, without limitation, methods, systems, and/or software products. Mainly by way of example, a method might comprise one or more procedures, any or all of which are executed by a computer system. Correspondingly, an embodiment might comprise a computer system configured with instructions to perform one or more procedures in accordance with methods of the invention. Similarly, a computer program might comprise a set of instructions that are executable by a computer system (and/or a processor therein) to perform such operations. In many cases, such software programs are encoded on physical and/or tangible computer readable media (such as, merely by way of example, optical media, magnetic media, and/or the like).

An exemplary method of providing a customer facing device (CFD) with language translation capabilities is described. The method may include receiving a card swipe from a presentation instrument for a financial transaction at the CFD. The method may further extract location information from the presentation instrument and, based on the extracted location information, determine a home language associated with the presentation instrument. Further, the method may present information displayed on the CFD in the home language.

An alterative exemplary embodiment of a system for providing a CFD with language translation capabilities is described. The system may include a CFD which has an input device configured to receive a card swipe from a presentation instrument and extract location information from the presentation instrument. The CFD may further include a storage device configured to store a language translation table. The language translation table may include translation information for a default language and at least one home language. Furthermore, based on the extracted location information, the home language may be selected from the entries within the language translation table.

The CFD may further include a display device configured to present visual information to a customer in the at least one home language and an output device configured to print a receipt in the default language and to print a receipt in the at least one home language. The system may further include a central service device coupled with the CFD. The central service device may be configured to provide the CFD with updates to the language translation table.

Another exemplary embodiment of a machine-readable medium for providing a CFD with language translation capabilities is described. The machine-readable medium may have sets of instructions which, when executed by a machine, cause the machine to receive a card swipe from a presentation instrument for a financial transaction at the CFD. The machine-readable medium may further cause the machine to extract location information from the presentation instrument and, based on the extracted location information, determine a home language associated with the presentation instrument. Further, the machine-readable medium may cause the machine to present information displayed on the CFD in the home language.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification to an existing sublabel, it is intended to refer to all such multiple similar components.

FIG. 1 is a flow diagram illustrating a method of providing language translation at a customer facing device, in accordance with various embodiments of the invention.

FIG. 2 is a flow diagram illustrating an additional method of providing language translation at a customer facing device, in accordance with various embodiments of the invention.

FIG. 3 is a block diagram illustrating a system for providing language translation at a customer facing device, in accordance with various embodiments of the invention.

FIG. 4 is a block diagram illustrating a customer facing device with language translation capabilities, in accordance with various embodiments of the invention.

FIG. 5 is a generalized schematic diagram illustrating a computer system, in accordance with various embodiments of the invention.

FIG. 6 is a block diagram illustrating a networked system of computers, which can be used in accordance with various embodiments of the invention.

### DETAILED DESCRIPTION OF THE INVENTION

While various aspects of embodiments of the invention have been summarized above, the following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below, and while various features are ascribed to different embodiments, it should be appreciated that the features described with respect to one embodiment may be incorporated with another embodiment as well. By the same token, however, no single feature or features of any described embodiment should be considered essential to the invention, as other embodiments of the invention may omit such features.

According to aspects of the present invention, a customer interacting with a customer facing device (CFD) may be dynamically presented with information (e.g., text strings and/or graphics) in their native language. For example, upon swiping a presentation instrument, the CFD may determine the country of issuance from information included on the presentation instrument that a language other than the CFD default language is needed. The customer may then be given the opportunity to choose such a language, and have the CFD present information in that language.

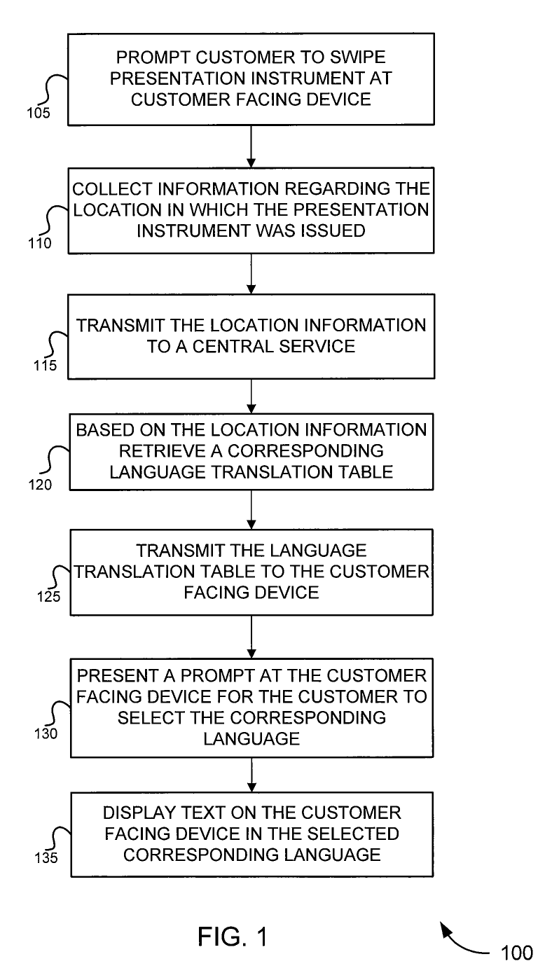

Turning now to FIG. 1 which illustrates one embodiment of a method 100 of providing language translation at a CFD according to aspects of the present invention. At process block 105, a customer may be prompted to swipe a presentation instrument at the CFD. In one embodiment, the CFD may be a point of sale (POS) device, an automated teller machine (ATM), a gas station pump interface, a web interface, a mobile device, a handheld device, a grocery or other merchant checkout device, etc. In a further embodiment, the presentation instrument may be a credit card, an ATM card, a debit card, a prepaid credit card, a gift or store credit card, etc.

In an alternative embodiment, the customer may not be prompted to swipe their presentation instrument, but instead may be able to swipe the presentation instrument at any time during the transaction. Furthermore, the customer may not even swipe the presentation instrument but may be able to move the presentation instrument to close proximity to the CFD in order to emulate a card swipe.

At process block 110, information regarding the country and/or location of issue of the presentation instrument may be collected. In one embodiment, this information may be collected from a magnetic stripe located on the presentation instrument. With credit cards, for example, the first six digits of the card may be used to determine the bank identification number (BIN) for the card. The BIN may then be used to determine the issuing region and country. Based on the region and country information a corresponding language can be determined. In an alternative embodiment, the customer may first swipe a credit card, a debit card, a driver's license (or other identification card), etc. to determine the location information, and then swipe the presentation instrument.

In one embodiment, several data points (e.g., issuing location, nationality of the customer, customer's current address, etc.) may be collected from the presentation instrument in order to determine the customer's desired language. In an alternative embodiment, the presentation instrument may include a “home language” entry stored within the presentation instrument. Accordingly, the home language may be determined based on such an entry.

In a further embodiment, after extracting the location and other information from the presentation instrument, the CFD may forward the information to a central service (process block 115). In one embodiment, the central service may be configured to determine the language associated with the presentation instrument as opposed to the CFD making the determination. The central service may retrieve a language table for the corresponding language once the determination has been made (process block 120). In one embodiment, the language table may include side-by-side columns with one column for a “default” language and multiple additional columns for each language translation. For example, the default column may include an entry for the term “cancel” and second, third, fourth and so on columns may include a translation of “cancel” in the column's language. However, other implementations of a translation table may be used.

In one embodiment, the language translation table may include the following:

TABLE 1
Bank Identification

| Number (BIN) | Home Country | Term | Translation |
|---|---|---|---|
| 075250 | Mexico | Signature | Firma |
| 045960 | China | Signature | [symbol] |

In a further embodiment, Table 1 may be further expanded to include additional languages and/or additional terms. Additionally, Table 1 is merely an example of how the language translation table may be configured, other configurations may be used.

In a further embodiment, if additional language translations are needed, the CFD and/or the central service may include additional columns in the translation table. Ultimately, any desired number of languages may be included in the language table in order to enable presentation to a customer in any language. Upon determination of the “home” language associated with the presentation instrument, the language table may be simplified to only include the default language and the determined language. At process block 125, the simplified version of the language table for the determined “home” language may be transmitted to the CFD. In an alternative embodiment, if the CFD stores the translation table, then no transmission of the table would be needed.

In one embodiment, the CFD may present the customer with a prompt for the customer to select between the default language and the home language (process block 130). However, in an alternative embodiment, the customer may not be prompted to select the home language, but the home language may automatically be displayed to the customer on the CFD. At process block 135, either automatically or after the customer has selected the home language from a prompt, information displayed on the CFD may then be in the home language.

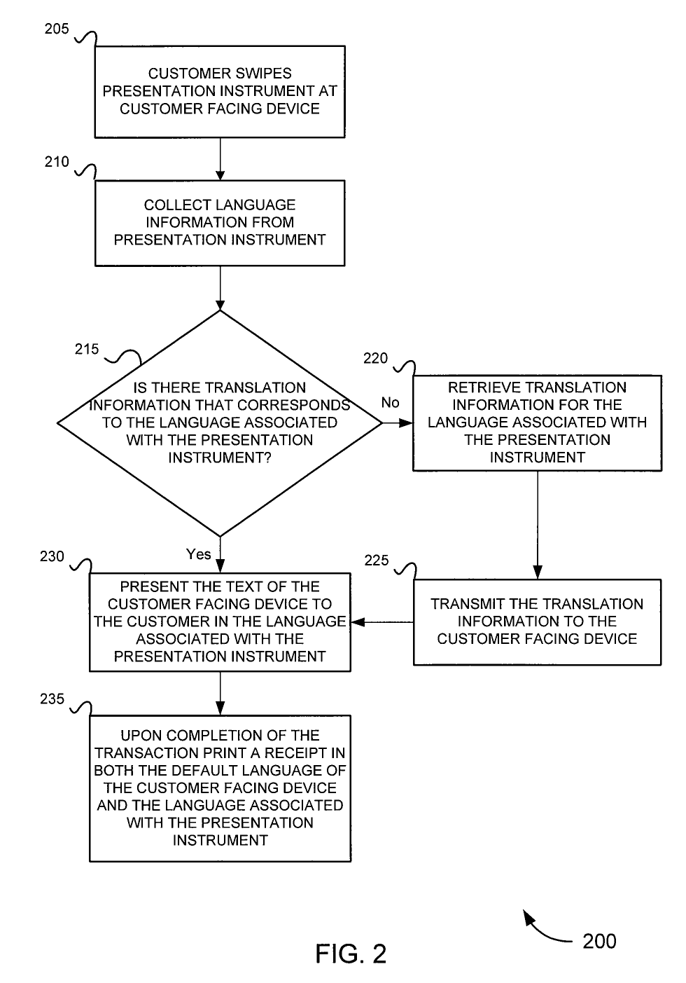

Describing FIG. 2 which illustrates one embodiment of a method 200 of providing language translation at a customer facing device according to aspects of the present invention. At process block 205, a customer may swipe a presentation instrument at a CFD. Similarly as described above, the CFD may collect language information from the presentation instrument (process block 210). Based on the language information collected, the CFD may then determine a “home” language of the customer. In an alternative embodiment, the CFD may be connected with a computer system on a network (e.g., a local area network (LAN), a wide area network (WAN), a dial-up network, etc.), also the computer system may be locally or remotely located with the CFD. Upon collection of the language information, the CFD may transmit the information to the computer system and the computer system may determine the customer's home language.

At decision block 215, a determination may be made whether the CFD includes the translation information associated with the customer's home language. If it is determined that the CFD does not include the translation information associated with the customer's home language, then the CFD may transmit a request to, for example, the computer system or the central service to retrieve the necessary translation information (process block 220). At process block 225, the translation information may then be transmitted to the CFD.

In one embodiment, if it is determined that the CFD includes the necessary translation information then the process moves to process block 230. At process block 230, the text presented to the customer on the CFD may be presented in the customer's “home” language. In one embodiment, if the CFD includes audio capabilities, then any audio presented to the customer may be presented in the “home” language. At process block 235, upon completion of the transaction, the CFD may print a receipt. In one embodiment, the receipt may have one copy in the merchant's “default” language and one copy in the customer's “home” language, or any such combination. In one embodiment, the merchant and/or the customer may be able to configure how receipts are printed.

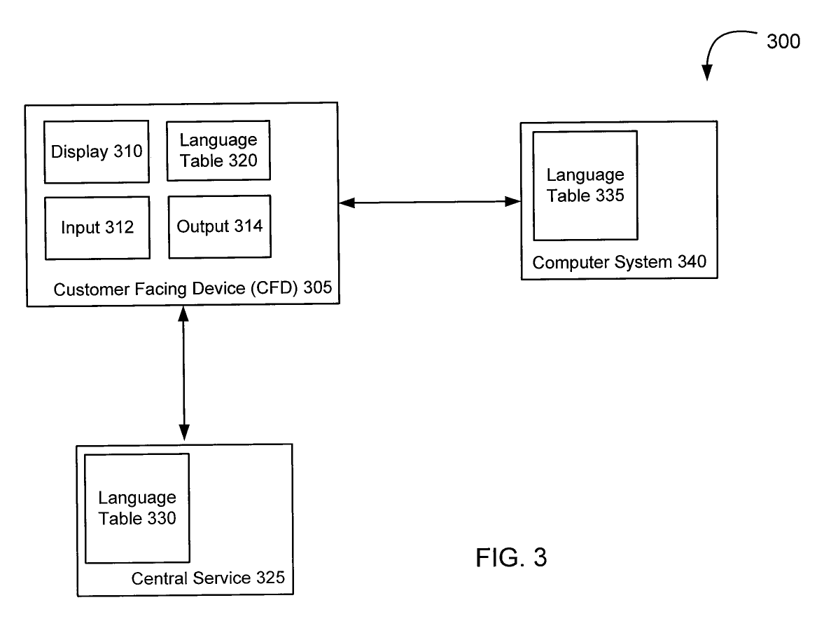

Now describing FIG. 3 which illustrates one embodiment of a system 300 for providing language translation at a CFD according to aspects of the present invention. In one embodiment, system 300 may include CFD 305, central service 325 and computer system 340. In one embodiment, CFD 305 may include display 310, input 312, output 314 and language table 320. Display 310 may be, for example, a liquid crystal display (LCD), a cathode ray tube (CRT), a monochrome display, etc. Display 310 may be used to display textual and graphical information to the customer in a default language and/or in a customer's “home” language.

In a further embodiment, input 312 may be a card swiping device to read a magnetic stripe from a presentation instrument. Alternatively, input 312 may be a proximity device which can read a smart chip and/or radio frequency (RF) transmitter from a presentation instrument. In one embodiment, output 314 may be a printing device capable of printing receipts and other related documents (e.g., coupons, informational printouts, etc.). The printing device may additionally be configured to print receipts and other documents in the customer's “home” language as well as in the default language.

In an additional embodiment, language table 320 may include language translations for various potential languages that may be associated with presentation instruments. In one embodiment, language table 320 may be able to receive additional language translations from, for example, central service 325 and/or computer system 340. Central service 325 may be coupled to CFD 305 and may also include a language table 330. In the situation where CFD 305 does not include language table 320, CFD 305 may access central service 325 's language table 330 in order to translate the text into the “home” language on CFD 305.

In a further embodiment, CFD 305 may extract location and/or language information from a presentation instrument in order to determine the customer's “home” language. In one embodiment, such a determination may be performed by CFD 305; however, in an alternative embodiment, computer system 340 and/or central service 325 may perform the determination and transmit translation information back to CFD 305. As such, computer system 340 may include translation table 335. Translation table 335 may include the necessary translation information used to display text and/or graphics to a customer on CFD 305.

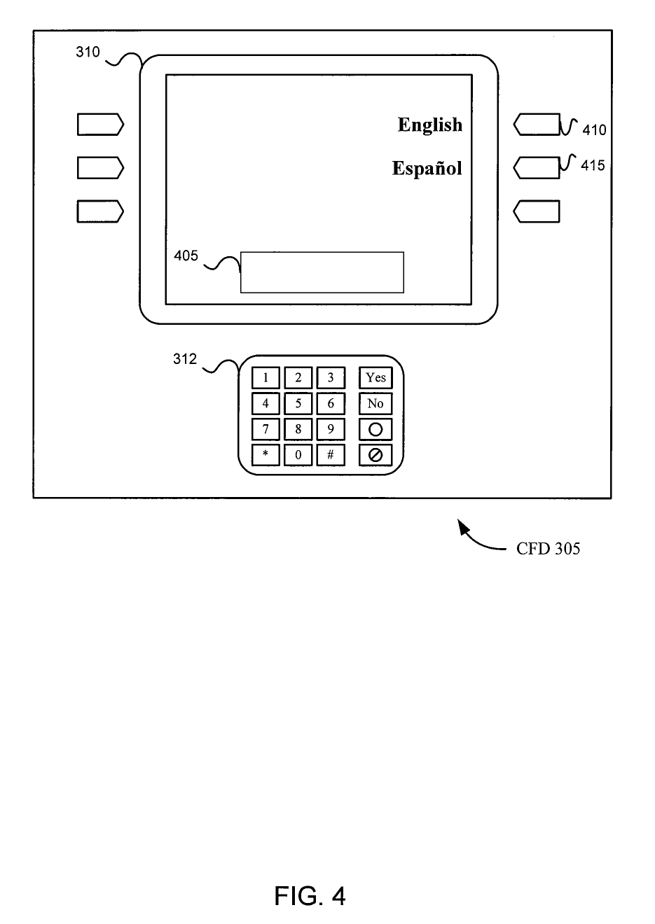

Turning now to FIG. 4 which illustrates one embodiment of CFD 305 according to aspects of the present invention. In one embodiment, CFD 305 may include a signature block 405. Signature block 405 may be configured to receive input from, for example, a stylus pen device in order for a customer to sign their name. In one embodiment, signature block 405 may be able to receive signatures in a variety of languages in order to correspond to the customer's “home” language.

In a further embodiment, CFD 305 may include input buttons 410 and 415. Input buttons 410 and 415 may have corresponding dynamic text associated with each button. For example, upon determination of the customer's “home” language, input buttons 415 and 420 may display the default language (i.e., English) and the “home” language (i.e., Espanol). Accordingly, the customer may be able to choose their desired language. Furthermore, the language for input 312 may also be changed to be displayed in the “home” language. As such, the number buttons and the “yes” and “no” buttons may be changed to be displayed in the “home” language. Consequently, any text and/or graphics displayed on CFD 305 may be translated into any customer's “home” language.

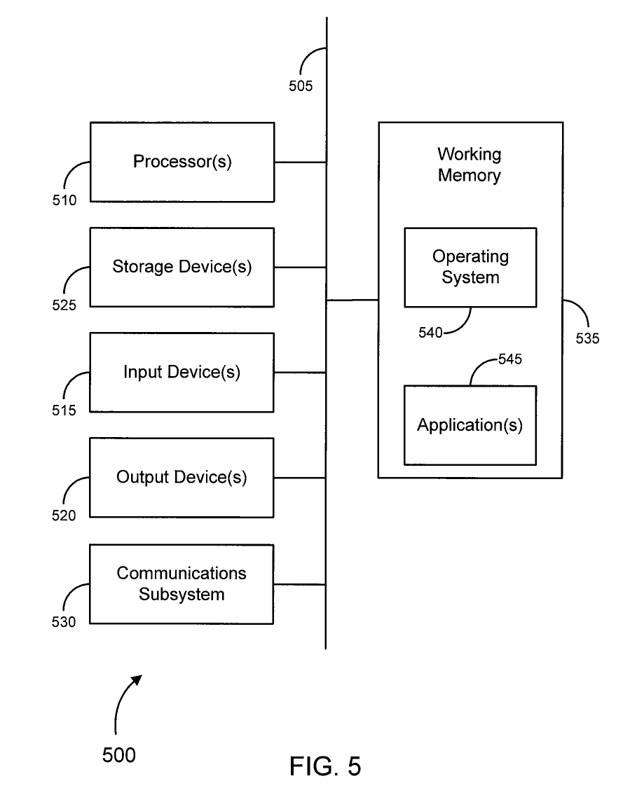

FIG. 5 provides a schematic illustration of one embodiment of a computer system 500 that can perform the methods of the invention, as described herein, and/or can function as, for example, CFD 305 (FIG. 3), central service 325 (FIG. 3), and/or computer system 340 (FIG. 3). It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505 (or may otherwise be in communication, as appropriate). The hardware elements can include one or more processors 510, including without limitation one or more general-purpose processors and/or one or more special-purpose processors (such as digital signal processing chips, graphics acceleration chips, and/or the like); one or more input devices 515, which can include without limitation a mouse, a keyboard and/or the like; and one or more output devices 520, which can include without limitation a display device, a printer and/or the like.

The computer system 500 may further include (and/or be in communication with) one or more storage devices 525, which can comprise, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computer system 500 might also include a communications subsystem 530, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 530 may permit data to be exchanged with a network (such as the network described below, to name one example), and/or any other devices described herein. In many embodiments, the computer system 500 will further comprise a working memory 535, which can include a RAM or ROM device, as described above.

The computer system 500 also can comprise software elements, shown as being currently located within the working memory 535, including an operating system 540 and/or other code, such as one or more application programs 545, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and or provided in an installation package, such that the storage medium can be used to program a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 500) to perform methods of the invention. According to a set of embodiments, some or all of the procedures of such methods are performed by the computer system 500 in response to processor 510 executing one or more sequences of one or more instructions (which might be incorporated into the operating system 540 and/or other code, such as an application program 545) contained in the working memory 535. Such instructions may be read into the working memory 535 from another machine-readable medium, such as one or more of the storage device(s) 525. Merely by way of example, execution of the sequences of instructions contained in the working memory 535 might cause the processor(s) 510 to perform one or more procedures of the methods described herein.

The terms “machine-readable medium” and “computer readable medium”, as used herein, refer to any medium that participates in providing data that causes a machine to operate in a specific fashion. In an embodiment implemented using the computer system 500, various machine-readable media might be involved in providing instructions/code to processor(s) 510 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 525. Volatile media includes, without limitation dynamic memory, such as the working memory 535. Transmission media includes coaxial cables, copper wire and fiber optics, including the wires that comprise the bus 505, as well as the various components of the communication subsystem 530 (and/or the media by which the communications subsystem 530 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc., carried by the signals) to the working memory 535, from which the processor(s) 505 retrieves and executes the instructions. The instructions received by the working memory 535 may optionally be stored on a storage device 525 either before or after execution by the processor(s) 510.

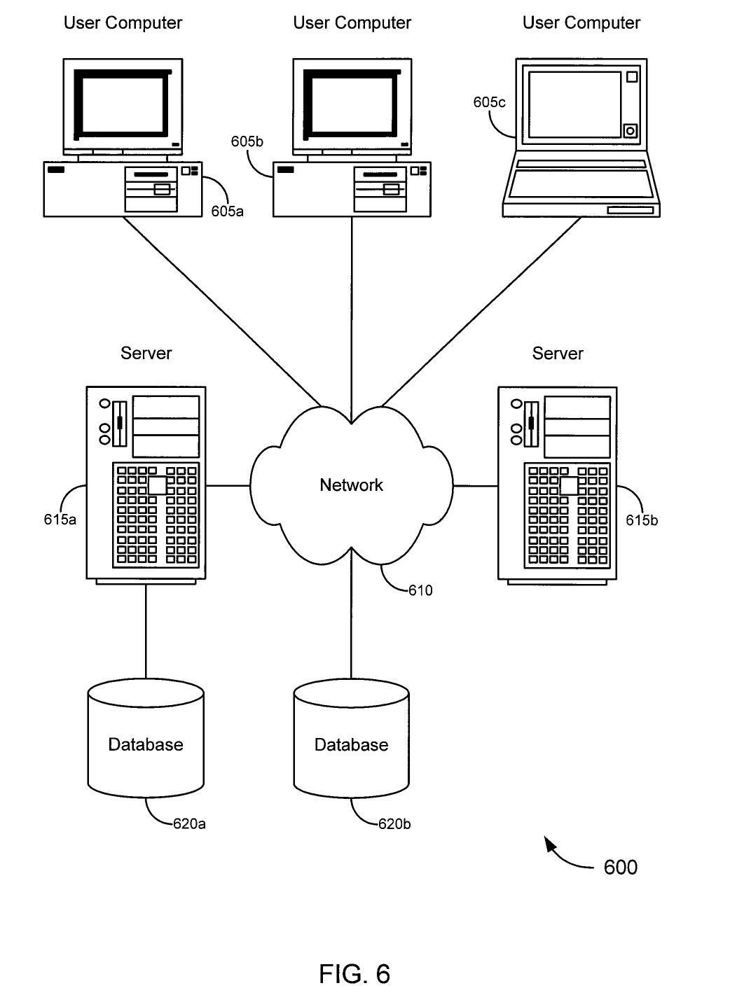

A set of embodiments comprises systems for providing a CFD with language translation capabilities. Merely by way of example, FIG. 6 illustrates a schematic diagram of a system 600 that can be used in accordance with one set of embodiments. The system 600 can include one or more user computers 605. The user computers 605 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computers 605 can also have any of a variety of applications, including one or more applications configured to perform methods of the invention, as well as one or more office applications, database client and/or server applications, and web browser applications. Alternatively, the user computers 605 can be any other electronic device, such as a thin-client computer, Internet-enabled mobile telephone, and/or personal digital assistant (PDA), capable of communicating via a network (e.g., the network 610 described below) and/or displaying and navigating web pages or other types of electronic documents. Although the exemplary system 600 is shown with three user computers 605, any number of user computers can be supported.

Certain embodiments of the invention operate in a networked environment, which can include a network 610. The network 610 can be any type of network familiar to those skilled in the art that can support data communications using any of a variety of commercially-available protocols, including without limitation TCP/IP, SNA, IPX, AppleTalk, and the like. Merely by way of example, the network 610 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 615. Each of the server computers 615 may be configured with an operating system, including without limitation any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 may be a web server, which can be used, merely by way of example, to process requests for web pages or other electronic documents from user computers 605. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 605 to perform methods of the invention.

The server computers 615, in some embodiments, might include one or more application servers, which can include one or more applications accessible by a client running on one or more of the client computers 605 and/or other servers 615. Merely by way of example, the server(s) 615 can be one or more general purpose computers capable of executing programs or scripts in response to the user computers 605 and/or other servers 615, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configuration, database clients, API clients, web browsers, etc.) running on a user computer 605 and/or another server 615. In some embodiments, an application server can create web pages dynamically for displaying the information in accordance with embodiments of the invention, such as a web interface for performing financial transactions. Data provided by an application server may be formatted as web pages (comprising HTML, Javascript, etc., for example) and/or may be forwarded to a user computer 605 via a web server (as described above, for example). Similarly, a web server might receive web page requests and/or input data from a user computer 605 and/or forward the web page requests and/or input data to an application server. In some cases a web server may be integrated with an application server.

In accordance with further embodiments, one or more servers 615 can function as a file server and/or can include one or more of the files (e.g., application code, data files, etc.) necessary to implement methods of the invention incorporated by an application running on a user computer 605 and/or another server 615. Alternatively, as those skilled in the art will appreciate, a file server can include all necessary files, allowing such an application to be invoked remotely by a user computer 605 and/or server 615. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620. The location of the database(s) 620 is discretionary: merely by way of example, a database 620a might reside on a storage medium local to (and/or resident in) a server 615a (and/or a user computer 605). Alternatively, a database 620b can be remote from any or all of the computers 605, 615, so long as it can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 620 can be a relational database, such as an Oracle™ database, that is adapted to store, update, and retrieve data in response to SQL-formatted commands. The database might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with-or without-certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method of providing a customer facing device (CFD) with language translation capabilities, the method comprising:
receiving a card swipe from a presentation instrument for a financial transaction at the CFD;
extracting location information from the presentation instrument;
based on the extracted location information, determining a home language associated with the presentation instrument; and
presenting information displayed on the CFD in the home language.

2. The method of claim 1, further comprising:
prior to presenting the information displayed on the CFD in the home language, presenting a prompt on the CFD to select at least one of a default language and the home language.

3. The method of claim 2, further comprising printing a receipt in the default language and the home language, wherein the receipt in the default language is for a merchant and the receipt in the home language is for a customer.

4. The method of claim 1, wherein the CFD is at least one of a point of sale (POS) device, an automated teller machine (ATM), a mobile device, and a website interface.

5. The method of claim 1, wherein the presentation instrument includes at least one of a magnetic stripe, a radio frequency (RF) chip, a biometric scanning device, a smart chip, and a memory storage device to store the location information.

6. The method of claim 1, wherein the presentation instrument is at least one of a credit card, an ATM card, a debit card, a prepaid credit card, and a gift card.

7. The method of claim 1, wherein the financial transaction is a wire transfer.

8. The method of claim 1, further comprising:
transmitting the extracted location information to a central service system; and
determining at the central service the home language associated with the extracted location information.

9. The method of claim 8, further comprising:
transmitting a language table to the CFD, wherein the language table includes a translation for each text string to be displayed on the CFD into the home language.

10. The method of claim 8, wherein the central service system is remotely located from the CFD.

11. The method of claim 8, wherein the central service system is locally located with the CFD.

12. The method of claim 1, wherein the location information is extracted from the presentation instrument based on at least one of an issuing bank identification number (BIN), a regional identification (ID), the customer's address information, and the presentation instrument's issuing location.

13. The method of claim 12, further comprising periodically updating BIN information to reflect current location information.

14. The method of claim 1, wherein the location information is extracted from at least one of a credit card of the customer, a debit card of the customer, the customer's drivers license, the customer identification card, and a bank card of the customer.

15. A system for providing a customer facing device (CFD) with language translation capabilities, the system comprising:
a CFD having:
an input device configured to receive a card swipe from a presentation instrument and to extract location information from the presentation instrument;
a storage device configured to store a language translation table to include translation information for a default language and at least one home language, wherein the at least one home language is selected from the language translation table based on the extracted location information;
a display device configured to present visual information to a customer in the at least one home language;
an output device configured to print a receipt in the default language and the at least one home language; and
a central service device coupled with the CFD configured to provide the CFD with updates to the language translation table.

16. The system of claim 15, further comprising a computer system coupled with the CFD configured to receive the extracted location information, based on the extracted location information determine an associated home language, and to transmit the determined home language to the CFD.

17. The system of claim 16, wherein the computer system is locally located with the CFD.

18. The system of claim 15, wherein the central service device includes a database configured to store translation information.

19. A machine-readable medium for providing a customer facing device (CFD) with language translation capabilities, the machine-readable medium having sets of instructions which, when executed by a machine, cause the machine to:
receive a card swipe from a presentation instrument for a financial transaction at the CFD;
extract location information from the presentation instrument;
based on the extracted location information, determine a home language associated with the presentation instrument; and
present information displayed on the CFD in the home language.

20. The machine-readable medium of claim 19, wherein the sets of instructions when executed by the machine, further cause the machine to map the information displayed on the CFD between a default language and the home language.

21. The machine-readable medium of claim 18, wherein the received card swipe is done at any time during the financial transaction.
